(19) United States
(12) Patent Application Publication
(10) Pub. No.: US 2014/0190722 A1
(43) Pub. Date: Jul. 10, 2014

(54) INCONSPICUOUS POWER CONDUIT

(71) Applicant: MONSTER ROUTE INC., Menlo Park, CA (US)

(72) Inventor: Sai Ming CHIANG, Menlo Park, CA (US)

(73) Assignee: MONSTER ROUTE INC., Menlo Park, CA (US)

(21) Appl. No.: 13/738,530

(22) Filed: Jan. 10, 2013

(51) Int. Cl. H02G 3/04; H01B 13/06; B23P 11/00

(52) U.S. Cl. CPC H02G 3/0406; B23P 11/00; H01B 13/06
USPC 174/95; 29/428; 29/825

(57) ABSTRACT

An inconspicuous power conduit that is substantially transparent or translucent may be used to provide power to an electronic device mounted on a transparent or translucent wall, such as a glass wall of a conference room. The longitudinal power conduit may be inconspicuous when mounted on a glass wall in comparison to traditional power cords or conduits because light passes through both the conduit and the glass wall causing the conduit to visually blend in with the wall. The conduit includes a first electrical conductor and a second electrical conductor which are connector to electrical connectors at the ends of the conduit. One connector may connect the conduit to a power source and the other connector may connect the conduit to an electronic device so that the power from the power source is connected to the electronic device.

### BACKGROUND

1. Field of the Disclosure

The embodiments described herein relate to an inconspicuous power conduit. The power conduit is substantially transparent and/or translucent. Thus, the conduit is substantially inconspicuous when mounted on a glass wall to connect a power source to an electronic device also mounted on or adjacent to a glass wall.

2. Description of the Related Art

In today's high tech world, it is very common to have one or more electronic devices, such as an Apple IPAD® or television monitor, mounted on the wall of a conference room. Cabling to connect the electronic device to a power source and/or other devices typically is positioned inside conventional conference room walls hiding the unsightly cables from view. However, high tech and/or more aesthetically pleasing conference rooms may use non-conventional walls, such as glass walls, that do not permit hiding the cables connected to an electronic device mounted on the non-conventional wall.

Running a power cable to an electronic device mounted on a glass wall of a conference room can be unsightly. The cable cannot be run inside of the glass wall, but instead must extend from either the floor or the ceiling and run on the exterior of the glass wall to the electronic device. Conventional power cord may visually contrast with the glass wall and may be considered unsightly in comparison to the otherwise aesthetically pleasing conference room. Generally conventional power cords are not translucent or transparent and thus, may visually contrast with a wall that is translucent and/or transparent.

A need exists to provide a power cord or conduit that may be used to connect a power source to an electronic device mounted on a glass wall that is more aesthetically pleasing than convention power cords.

### SUMMARY

The present disclosure is directed to an inconspicuous power conduit that may be used to connect a power source to an electronic device mounted on a glass wall. The inconspicuous power conduit is a substantially translucent or transparent conduit that when mounted to a glass wall minimizes the visual contrast between the conduit and the glass wall in comparison to traditional power cords.

One embodiment is an inconspicuous power conduit comprising a substantially translucent longitudinal conduit having a first end and a second end. The inconspicuous power conduit includes first and second electrical conductors that extend from the first end to the second end within the conduit. The longitudinal conduit may be substantially transparent. The first and second electrical conductors may be within first and second recesses within the conduit that extend between the ends of the conduit. The longitudinal conduit may include a first connector that connects the first and second electrical conductors to a power source. The longitudinal conduit may include a second connector that connects the first and second electrical conductors to an electronic device. The electronic device may be mounted to a glass wall. The glass wall may be colored glass and the conduit may be comprised a translucent material that substantially corresponds to the color of the glass. The conduit may comprise a flat surface that extends from the first end to the second end. The first recess of the conduit may comprise a groove that extends along a first side of the conduit and the second recess of the conduit may comprise a groove that extends along a second side of the conduit.

One embodiment is a method of connecting an electronic device to a power source. The method comprises providing a substantially translucent longitudinal conductor having a first end and a second end, positioning a first electrical conductor within the substantially translucent longitudinal conduit, and position a second electrical conductor within the substantially translucent longitudinal conduit. The method includes connecting a first end of the first electrical conductor and a first end of the second electrical conductor to a power source. The method includes connecting a second end of the first electrical conductor and a second end of the second electrical conductor to the electronic device.

The method may include mounting the electronic device to a glass wall. The longitudinal conduit of the method may be substantially transparent. The method may comprise providing a first recess in the substantially translucent conduit that extends from the first end to the second end and providing a second recess in the substantially translucent conduit that extends from the first end to the second end. The method may comprise positioning the first electrical conductor within the first recess and positioned the second electrical conductor within the second recess. The method may comprise providing a first groove in the substantially translucent longitudinal conduit that extends from the first end to the second end and providing a second groove in the substantially translucent longitudinal conduit that extends from the first end to the second end. The method may comprise positioning the first electrical conductor within the first groove and positioning the second electrical conductor within the second groove.

### BRIEF DESCRIPTION OF THE DRAWINGS

FIG. 1 shows one embodiment of an inconspicuous power conduit;

FIG. 2 shows one embodiment of an inconspicuous power conduit; and

FIG. 3 shows one embodiment of an inconspicuous power conduit connected to an electronic device mounted on a glass wall.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the invention as defined by the appended claims.

### DETAILED DESCRIPTION

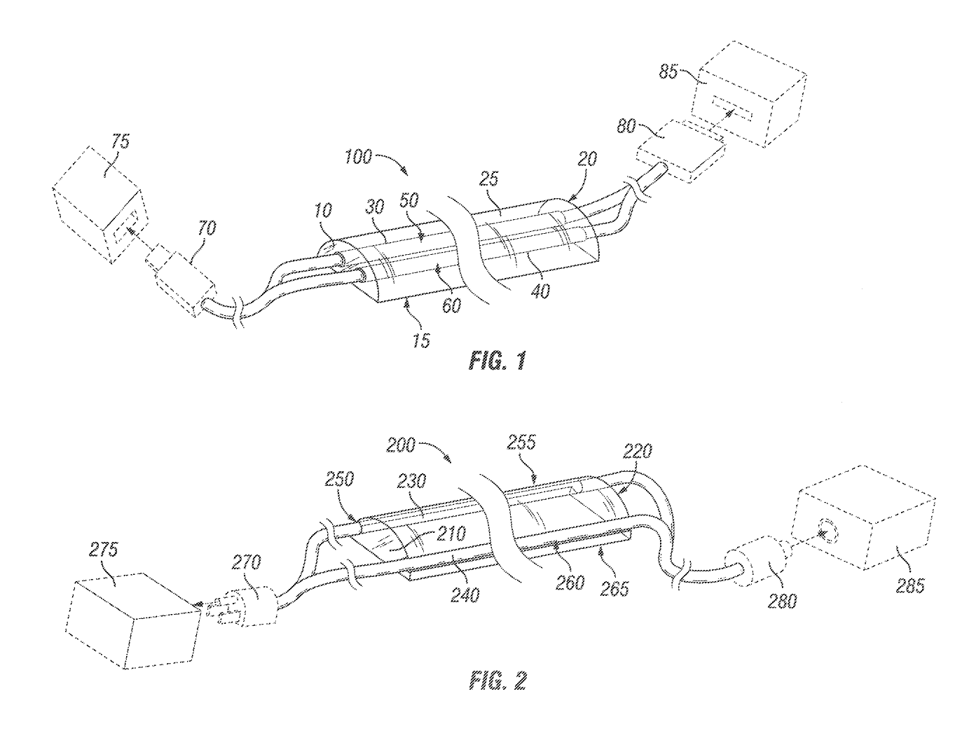

FIG. 1 shows an inconspicuous power conduit 100, which is a longitudinal conduit that includes a first end 10 and a second end 20, the conduit being substantially translucent or transparent allowing the conduit 100 to be inconspicuous when mounted on a glass wall in comparison to traditional power cords and/or conduits. Because the conduit is substantially transparent or translucent, light passes through both the conduit and the glass wall upon which the conduit 100 is mounted causing the conduit 100 to visually blend in with the wall in comparison to traditional power cords and/or conduits. Both transparent and translucent conduits 100 permit light to pass through the conduit, but an object on the other side of a translucent conduit 100 may not be clear whereas an object on the other side of a transparent conduit 100 is substantially clear. As both transparent and translucent conduits 100 permit the passage of light through the conduit 100, both types of conduits 100 may be inconspicuous when mounted on a translucent or transparent surface.

The inconspicuous power conduit 100 includes a first electrical conductor 30 and a second electrical conductor 40 each that extends from the first end 10 to the second end 20 of the substantially transparent longitudinal conduit 100. The first electrical conductor 30 is positioned within a first recess 50 within the inconspicuous power conduit 100. The second electrical conductor 40 is positioned within a second recess 60 within the inconspicuous power conduit 100. The inconspicuous power conduit 100 may be a solid substantially transparent longitudinal conduit with the first and second recesses 50 and 60 with the conduit. The recesses may be formed within the conduit 100 by various means. For example, the recesses 50 and 60 may be drilled, bored, or the conduit 100 may be extruded to include the recesses 50 and 60. The inconspicuous power conduit 100 may be a conduit that is formed with two integral recesses 50 and 60 that extend the length of the conduit 100.

A connector 70 is connected to the first electrical conductor 30 and the second electrical conductor 40 at the first end 10 of the inconspicuous power conduit 100. The connector 70 connects both the first electrical conductor 30 and the second electrical conductor 40 to a power source 75. A connector 80 is connected to the first electrical conductor 30 and the second electrical conductor 40 at the second end 20 of the inconspicuous power conduit 100. The connector 80 connects both the first electrical conductor 30 and the second electrical conductor 40 to an electronic device 85. Preferably, the inconspicuous power conduit 100 may be used to connect an electronic device 85 to a low voltage power source 75, such as a power supply that provides 5 watts of 5 volt power. The substantially transparent longitudinal conduit 100 may include a substantially rounded top surface 25 and a flat bottom surface 15, which may aid in the mounting of the substantially transparent longitudinal conduit 100 to a transparent surface, such as a glass wall.

FIG. 2 shows an inconspicuous power conduit 200, which is a substantially transparent or translucent longitudinal conduit that includes a first end 210 and a second end 220. The inconspicuous power conduit 200 includes a first electrical conductor 230 and a second electrical conduct each that extends from the first end 210 to the second end 240 of the substantially transparent longitudinal conduit. The first electrical conductor 230 is positioned within a first groove 250 within the inconspicuous power conduit 200. The second electrical conductor 240 is positioned within a second groove 260 within the inconspicuous power conduit 200. The inconspicuous power conduit 200 may be a solid substantially transparent longitudinal conduit with the first groove 250 along a first side 255 of the conduit 200 and the second groove 260 along a second side 265 of the conduit 200. The first and second grooves 250 and 260 may be machined into the conduit 200 or the conduit may be formed with the integral grooves 250 and 260. The conduit 200 may be extruded including grooves 250 and 260 along the length of the sides of the conduit 200. The conduit 200 may be formed by various means to integrally include the grooves 250 and 260.

A connector 270 is connected to the first electrical conductor 230 and the second electrical conductor 240 at the first end 210 of the inconspicuous power conduit 200. The connector 270 connects both the first electrical conductor 230 and the second electrical conductor 240 to a power source 275. A connector 280 is connected to the first electrical conductor 230 and the second electrical conductor 240 at the second end 220 of the inconspicuous power conduit 200. The connector 280 connects both the first electrical conductor 230 and the second electrical conductor 240 to an electronic device 285.

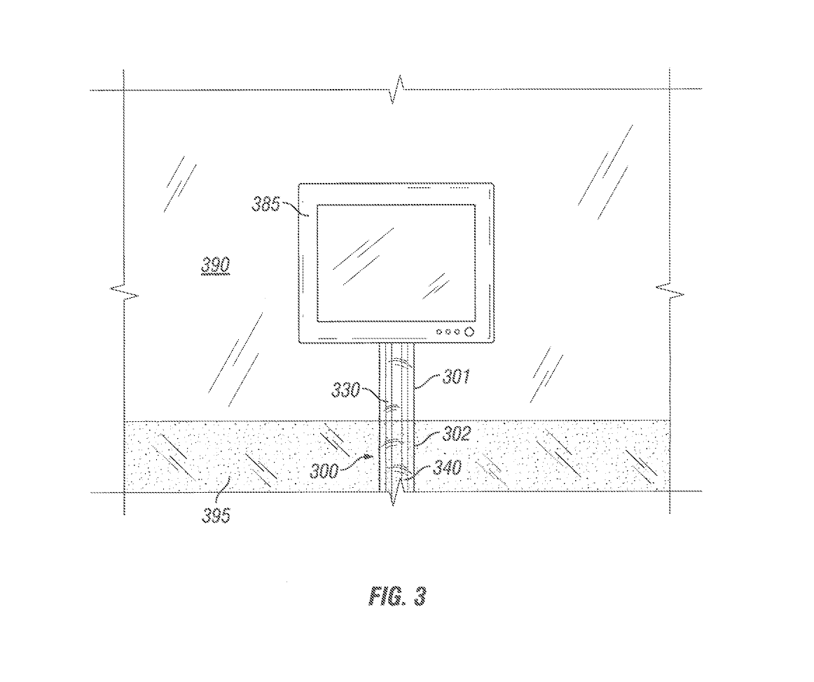

FIG. 3 shows the first and second electrical conducts 330 and 340 of a substantially transparent or translucent longitudinal conduit 300 connected to an electronic device 385 via a connector (not shown). The longitudinal conduit 300 may run substantially adjacent to the electronic device 385 so that the mounted electronic device 385 substantially obscures the connector and any connection wires extending from the conduit 300. The electronic device 385 is mounted to a glass wall 390, which may be a glass wall of a conference room. The substantially transparency or translucency of the conduit 300 conceals the conduit 300 when mounted or adjacent the glass wall 390 in comparison to a traditional power cord. The glass wall 390 may be tinted and/or colored and the conduit 300 may be tinted and/or colored to match the tint and/or color of the glass wall 390. FIG. 3 shows that the glass wall includes both a clear panel 390 and a colored panel 395. The conduit 300 includes a clear portion 301 and a colored portion 302 that substantially corresponds to the clear panel 390 and the colored panel 395 respectively. The use of two different panels 390 and 395 and the conduit 300 including two different portions 301 and 302 is for illustrative purposes only. For example, the conduit 300 could comprise multiple portions or a single portion that substantially corresponds to the color the translucent and/or transparent wall onto which the conduit 300 is to be mounted.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

TABLE OF REFERENCE NUMERALS FOR FIGS. 1-3

```
  10 end of conduit
  15 flat surface of conduit
  20 end of conduit
  25 rounded top surface of conduit
  30 electrical conductor
  40 electrical conductor
  50 recess within conduit
  60 recess within conduit
  70 electrical connector
  75 power source
  80 electrical connector
  85 electronic device
100 conduit
200 conduit
210 end of conduit
220 end of conduit
230 electrical conductor
240 electrical conductor
250 groove in conduit
255 side of conduit
260 groove in conduit
265 side of conduit
270 electrical connector
275 power source
280 electrical connector
285 electronic device
300 conduit
301 clear portion of conduit
302 colored/tinted portion of conduit
330 electrical conductor
340 electrical conductor
385 electronic device
390 glass wall
395 tinted/colored glass panel
```

What is claimed is:

1. An inconspicuous power conduit comprising:
a substantially translucent longitudinal conduit having a first end and a second end;
a first electrical conductor within the substantially translucent longitudinal conduit, the first electrical conductor extending from the first end to the second end of the conduit;
a second electrical conductor within the substantially translucent longitudinal conduit, the second electrical conductor extending from the first end to the second end of the conduit.

2. The inconspicuous power conduit of claim 1, wherein the longitudinal conduit is substantially transparent.

3. The inconspicuous power conduit of claim 1 further comprising:
a first recess within the conduit, the first recess extending from the first end to the second end of the conduit, the first electrical conductor being within first recess; and
a second recess within the conduit, the second recess extending from the first end to the second end of the conduit, the second electrical conduit being within the second recess;

4. The inconspicuous power conduit of claim 3 further comprising a first connector at the first end of the conduit, the first connector configured to connect the first and second electrical conductors to a power source.

5. The inconspicuous power conduit of claim 4 further comprising a second connector at the second end of the conduit, the second connector configured to connect the first and second electrical conductors to an electronic device.

6. The inconspicuous power conduit of claim 5, wherein the electronic device is mounted to a glass wall.

7. The inconspicuous power conduit of claim 6, wherein the glass wall is colored glass and the conduit comprises a translucent material that substantially corresponds to the color of the glass wall.

8. The inconspicuous power conduit of claim 1, the conduit further comprising a flat surface that extends from the first end to the second end.

9. The inconspicuous power conduit of claim 3, wherein the first recess comprises a groove that extends along a first side of the conduit.

10. The inconspicuous power conduit of claim 9, wherein the second recess comprises a groove that extends along a second side of the conduit.

11. A method of connecting an electronic device to a power source, the method comprising:
providing a substantially translucent longitudinal conduit having a first end and a second end;
positioning a first electrical conductor within the substantially translucent longitudinal conduit;
positioning a second electrical conductor within the substantially translucent longitudinal conduit;
connecting a first end of the first electrical conductor and a first end of the second electrical conductor to a power source;
connecting a second end of the first electrical conductor and a second end of the second electrical conductor to the electronic device.

12. The method of claim 11 further comprising mounting the electronic device to a glass wall.

13. The method of claim 11, wherein the longitudinal conduit is substantially transparent.

14. The method of claim 11 further comprising providing a first recess in the substantially translucent longitudinal conduit that extends from the first end of the substantially translucent longitudinal conduit to the second end of the substantially translucent longitudinal conduit.

15. The method of claim 14 further comprising providing a second recess in the substantially translucent longitudinal conduit that extends from the first end of the substantially translucent longitudinal conduit to the second end of the substantially translucent longitudinal conduit.

16. The method of claim 15, wherein positioning the first electrical conductor further comprises positioning the first electrical conductor within the first recess and wherein positioning the second electrical conductor further comprises positioning the second electrical conductor within the second recess.

17. The method of claim 11 further comprising providing a first groove in the substantially translucent longitudinal conduit that extends from the first end of the substantially translucent longitudinal conduit to the second end of the substantially translucent longitudinal conduit.

18. The method of claim 17 further comprising providing a second groove in the substantially translucent longitudinal conduit that extends from the first end of the substantially translucent longitudinal conduit to the second end of the substantially translucent longitudinal conduit.

19. The method of claim 18, wherein positioning the first electrical conductor further comprises positioning the first electrical conductor within the first groove and wherein positioning the second electrical conductor further comprises positioning the second electrical conductor within the second groove.
